(19) United States
(12) Patent Application Publication
(10) Pub. No.: US 2014/0195329 A1
(43) Pub. Date: Jul. 10, 2014

(54) SYSTEMS, METHODS, AND MEDIA FOR PRESENTING AN ADVERTISEMENT

(71) Applicants: Jeffrey N. Marcus, Newtown, PA (US); Robert Allen Wyke, Chapel Hill, NC (US)

(72) Inventors: Jeffrey N. Marcus, Newtown, PA (US); Robert Allen Wyke, Chapel Hill, NC (US)

(21) Appl. No.: 14/078,341

(22) Filed: Nov. 12, 2013

Related U.S. Application Data
(60) Provisional application No. 61/725,037, filed on Nov. 12, 2012.

(51) Int. Cl. G06Q 30/02

(52) U.S. Cl. CPC G06Q 30/0275; G06Q 30/0277; G06Q 30/0242
USPC 705/14.41; 705/14.73; 705/14.71

(57) ABSTRACT

Systems, methods, and media for presenting an advertisement are provided. In some embodiments, systems for presenting an advertisement are provided, the systems comprising: at least one hardware processor that: receives information relating to an advertisement space; determines at least one score for each of a plurality of segments for a potential advertisement for the advertisement space; selects a segment from the plurality of segments for the advertisement space based on the at least one score for the plurality of segments; selects an advertisement for the segment selected; and causes the advertisement to be presented in the advertisement space.

### CROSS REFERENCE TO RELATED APPLICATION

This application claims the benefit of U.S. Provisional Patent Application No. 61/725,037, filed Nov. 12, 2012, which is hereby incorporated by reference herein in its entirety.

### TECHNICAL FIELD

Systems, methods, and media for presenting an advertisement are provided.

### BACKGROUND

Generally, in targeted online advertising, a Web site publisher tags its pages with categories and/or segments, such as Health, Diabetes or Sports. When a Web site visitor views a Web page on that Web site, an advertisement network writes information regarding the visits to a local cookie file stored by the visitor's browser. For example, if there is a Sports field in the cookie and the Web site has sports content, the network might increment a counter in the Sports field. A higher counter in the Sports field may mean that the visitor is a greater sports enthusiast. The advertisement network can read the cookie to make a targeted advertisement decision. For example, if a visitor has a Sports counter greater than three, then he can be presumed to be a sports enthusiast. In that case, he may be shown a sports advertisement, even if he is on a non-sports page.

However, the success of such targeted advertising is based in part on the quality of the tags. Mistakes on the tags can lead to incorrect advertisement targeting. Likewise, the tags may not have the level of detail needed for the advertisement network to make the best decision. Therefore, tags may not be high quality, for example, because the publisher may not have the proper insight to tag the Web pages to the needs of the advertisers.

Accordingly, the need exists for new systems, methods, and media for presenting an advertisement.

### SUMMARY

Systems, methods, and media for presenting an advertisement are provided. In some embodiments, systems for presenting an advertisement are provided, the systems comprising: at least one hardware processor that: receives information relating to an advertisement space; determines at least one score for each of a plurality of segments for a potential advertisement for the advertisement space; selects a segment from the plurality of segments for the advertisement space based on the at least one score for the plurality of segments; selects an advertisement for the segment selected; and causes the advertisement to be presented in the advertisement space.

In some embodiments, methods for presenting an advertisement are provided, the methods comprising: receiving, using a hardware processor, information relating to an advertisement space; determining, using the hardware processor, at least one score for each of a plurality of segments for a potential advertisement for the advertisement space; selecting a segment from the plurality of segments for the advertisement space based on the at least one score for the plurality of segments; selecting an advertisement for the segment selected; and causing the advertisement to be presented in the advertisement space.

In some embodiments, non-transitory computer-readable media containing computer-executable instructions that, when executed by a hardware processor, cause the processor to perform a method for presenting an advertisement are provided, the method comprising: receiving information relating to an advertisement space; determining at least one score for each of a plurality of segments for a potential advertisement for the advertisement space; selecting an advertisement for the advertisement space based on the at least one score for the plurality of segments; selecting an advertisement for the segment selected; and causing the advertisement to be presented in the advertisement space.

### BRIEF DESCRIPTION OF THE DRAWINGS

FIG. 1 shows a generalized schematic diagram of an example of a system that can be used for presenting an advertisement in accordance with some embodiments of the disclosed subject matter.

FIG. 2 shows a diagram illustrating an example of three processes that can be used for presenting an advertisement in accordance with some embodiments of the disclosed subject matter.

FIG. 3 shows a diagram illustrating an example of four processes that can be used for presenting an advertisement in accordance with some embodiments of the disclosed subject matter.

FIG. 4 shows a diagram illustrating an example of a process for determining a ranking table of a plurality of advertisement spaces and one or more segments for each advertisement space in accordance with some embodiments of the disclosed subject matter.

FIG. 5 shows an example of a ranking table of a plurality of advertisement spaces and one or more segments for each advertisement space in accordance with some embodiments of the disclosed subject matter.

FIG. 6 shows an example of a ranking table of a plurality of advertisement spaces and one or more segments for each advertisement space in accordance with some embodiments of the disclosed subject matter.

FIG. 7 shows an example of a process for presenting an advertisement in accordance with some embodiments of the disclosed subject matter.

FIG. 8 shows examples of specific hardware for a server and/or a client in accordance with some embodiments of the disclosed subject matter.

### DETAILED DESCRIPTION

In accordance with some embodiments, mechanisms (which can include systems, methods, and/or computer readable media) for presenting an advertisement are provided. Generally speaking, these mechanisms can receive a selection of an advertisement space, receive a selection of a segment for a potential advertisement to be presented in the advertisement space (e.g., medical condition, demographic, and/or any other suitable categorization of an advertisement), determine at least one score for the advertisement space and the segment, select an advertisement based on the at least one score, and cause the advertisement to be presented in the advertisement space.

The mechanisms can be used to perform a variety of functions. For example, these mechanisms can be used to target advertisements, such as to target an online targeted advertisement. In a more particular example, these mechanisms can be used to target a Web based targeted advertisement, a mobile based targeted advertisement, and/or any other suitable targeted advertisement.

In some embodiments, in response to a request for an advertisement for a Web page, the mechanisms can select an advertisement for the Web page based a ranking table of a plurality of advertisement spaces (e.g., URL, location on a Web page, and/or any other suitable identifier of a place in which an advertisement can be presented). The mechanisms can rank each advertisement space based on one or more scores for a segment (e.g., medical condition, demographic, and/or any other suitable categorization of an advertisement). The mechanisms can use relevance of the advertisement space, location (e.g., IP address, zip code, and/or any other suitable identifier of a geographic place or area), other factors (e.g., weather data, social data, and/or any other suitable factor relating to a recipient of the advertisement and/or a product or service related to the advertisement), and performance data (e.g., user clicks, survey results, and/or any other suitable data relating to the performance of the advertisement) to determine the score of the segment. In some embodiments, the mechanisms can determine whether to present targeted advertisements on a computing device, such as a personal computer, a gaming device, a set-top box, a television, a mobile device, such as on a mobile phone, a tablet computer, a laptop computer, and/or any other suitable device, and, if so, which targeted advertisements to present.

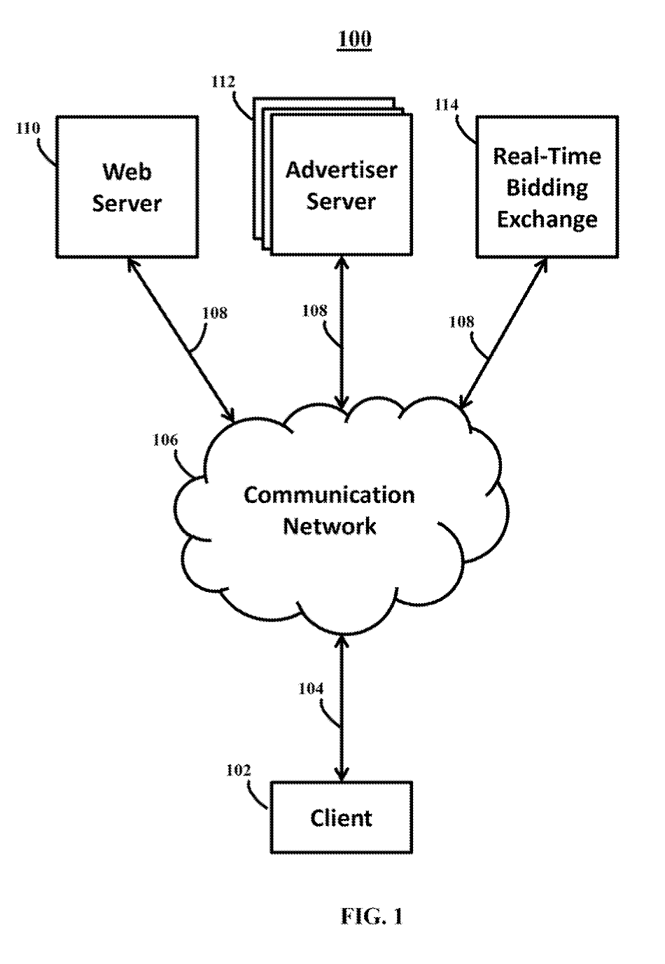

These and other features for targeting advertisements are described further in connection with FIGS. 1-8.

FIG. 1 is a generalized schematic diagram of a system 100 on which presenting an advertisement mechanisms can be implemented in accordance with some embodiments of the disclosed subject matter. System 100 can include one or more clients 102, such as a client for a targeted advertisement. Clients 102 can be local to each other or remote from each other. Client 102 can be connected by one or more communication links 104 to a communication network 106.

System 100 can also include one or more servers, such as Web server 110, advertiser server 112, and real-time bidding exchange server 114, and/or any other suitable server(s). Server 110, server 112, and/or server 114 can each be any suitable server for targeting advertisements, such as a hardware processor, a computer, a data processing device, or a combination of such devices. Servers 110, 112, and 114 can be linked to communications network 106 via communications links 108.

Client 102, server 110, server 112, and/or server 114 can be any of a general purpose device such as a computer or a special purpose device such as a client, a server, and/or any other suitable device for performing the functions described herein. Any of these general or special purpose devices can include any suitable components such as a hardware processor (which can be a microprocessor, digital signal processor, a controller, and/or any other suitable device for executing instructions and/or performing the functions described herein), memory, communication interfaces, display controllers, input devices, and/or any other suitable device for performing the functions described herein. For example, client 102 can be implemented as a personal computer, a tablet computing device, a personal data assistant (PDA), a portable email device, a multimedia terminal, a mobile telephone, a gaming device, a set-top box, a television, and/or any other suitable device for presenting advertisements.

Although servers 110, 112, and 114 are illustrated in FIG. 1 as being separate devices, any two or more of these servers can be implemented in a single device in some embodiments. Also, servers 110, 112, and/or 114 can be implemented in one or more virtual environments that are implemented on any one or more general purpose device(s) or special purpose device(s) (as described above), and zero, one, or more other virtual environments can also be implemented on each of such general purpose device or special purpose device.

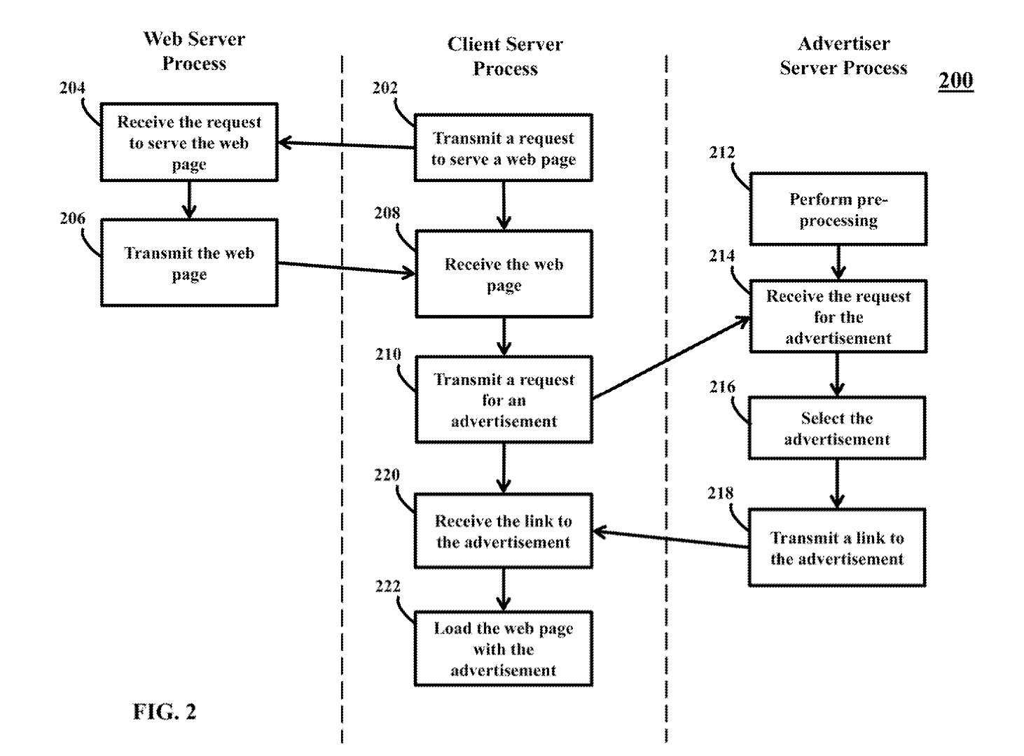

Turning to FIG. 2, a diagram illustrating an example 200 of three processes that can be used for presenting an advertisement is provided. As shown, example 200 can include a Web server process, a client server process, and an advertiser server process.

In some embodiments, example 200 can start by the client server process transmitting a request to serve a Web page to the Web server process at 202. In response to receiving the request to serve the Web page at 204, the Web server process can transmit the Web page back to the client server process at 206. After receiving the web page at 208, the client server process can transmit a request for an advertisement for the Web page to the advertiser server process at 210 based on information received with the Web page.

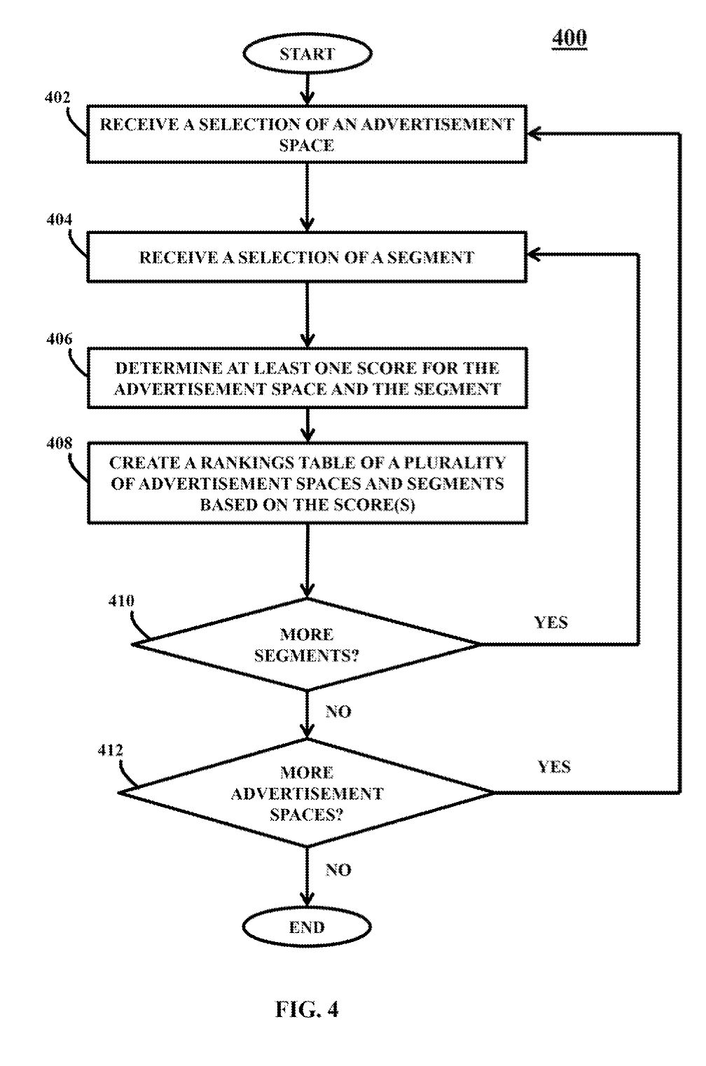

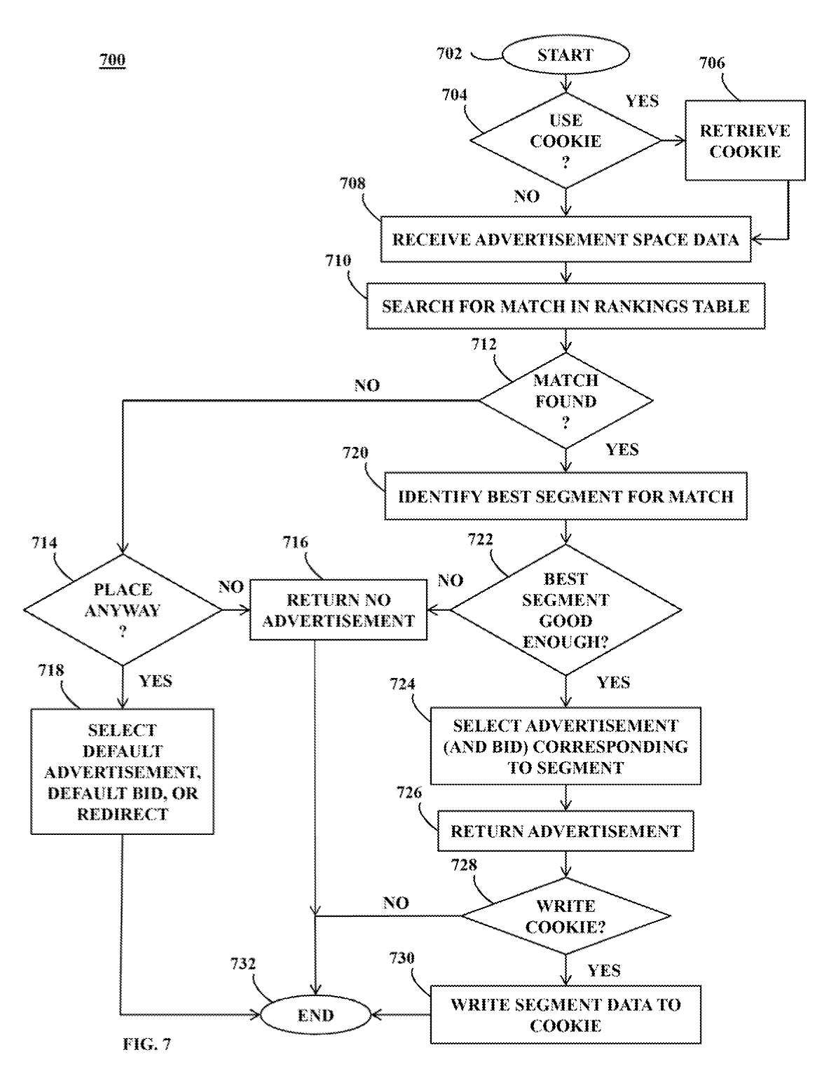

In some embodiments, after performing preprocessing (e.g., creating a ranking table of a plurality of advertisement spaces and one or more segments for each advertisement space) at 212 (e.g., as described below in connection with FIG. 4, for example), the advertiser server process can receive the request for the advertisement at 214. The advertiser server process can select the advertisement at 216 (e.g., as described below in connection with FIG. 7, for example). In response to selecting the advertisement, the advertiser server process can transmit a link to the advertisement to the client server at 218. In some embodiments, the client server process can receive the link to the advertisement at 220 and load the Web page with the advertisement in any suitable manner at 222.

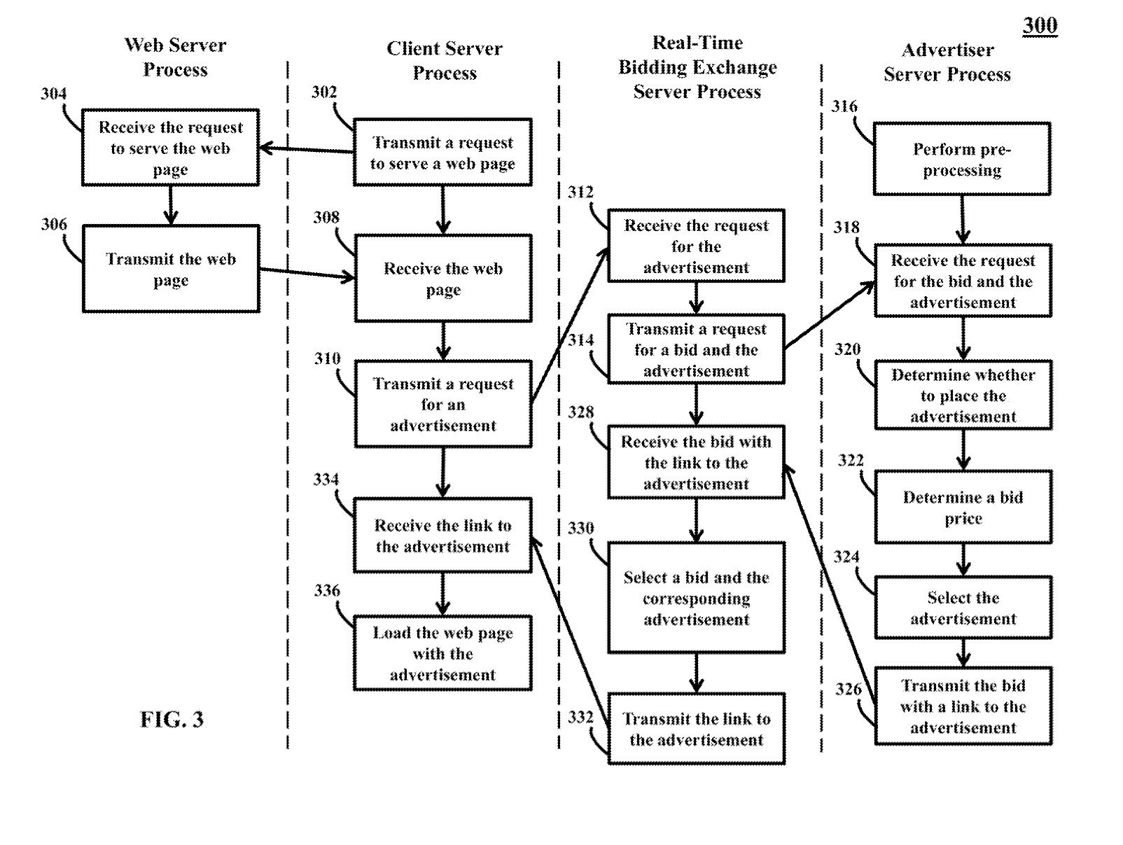

Turning to FIG. 3, a diagram illustrating an example 300 of four processes that can be used for presenting an advertisement is provided. As shown, example 300 can include a Web server process, a client server process, a real-time bidding exchange server process, and an advertiser server process.

In some embodiments, example 300 can start by the client server process transmitting a request to serve a Web page to the Web server process at 302. In response to receiving the request to serve the Web page at 304, the Web server process can transmit the Web page back to the client server process at 306. After receiving the Web page at 308, the client server process can transmit a request for an advertisement for the Web page to the real-time exchange server process at 310 based on information received with the Web page.

In response to receiving the request for the advertisement at 312, the real-time bidding exchange server process can transmit a request for a bid and a corresponding advertisement for the Web page at 314. In some embodiments, after performing preprocessing (e.g., creating a ranking table of the plurality of advertisement spaces and one or more segments for each advertisement space) at 316 (e.g., as described below in connection with FIG. 4, for example), the advertiser server process can receive the request for the bid and the corresponding advertisement at 318. In response to receiving the request for the bid and the corresponding advertisement, the advertiser server process can determine whether to place an advertisement at 320 (e.g., as described below in connection with FIG. 7, for example).

In some embodiments, in response to determining to place the advertisement, the advertiser server process can determine the bid price in any suitable manner at 322 and select the corresponding advertisement at 324 (e.g., as described below in connection with FIG. 7, for example). After determining the bid price and selecting the corresponding advertisement, the advertiser server process can transmit the bid and a link to the corresponding advertisement to the real-time bidding exchange server process at 326.

In some embodiments, the real-time bidding exchange server process can receive the bid and the link to the corresponding advertisement at 328. For example, the real-time bidding exchange server process can receive one or more bids and corresponding advertisements. After receiving one or more bids and links to corresponding advertisements, the real-time bidding exchange server process can select a bid and the corresponding advertisement at 330.

In some embodiments, the real-time bidding exchange server process can transmit the link to the advertisement to the client server process at 332. The client server process can receive the link to the advertisement at 334 and load the Web page with the advertisement in any suitable manner at 336.

Turning to FIG. 4, an example 400 of a process for determining a ranking table of a plurality of advertisement spaces and one or more segments for each advertisement space is provided. In some embodiments, process 400 can be a preprocessing process performed in advertiser server 112 of FIG. 1.

As shown, process 400 can start by receiving a selection of an advertisement space at 402. For example, process 400 can receive a selection of an advertisement space for a potential advertisement to be presented in the selected advertisement space. In some embodiments, the advertisement space can be a Web site, a Web page, a uniform resource locator (URL), a particular space on a particular Web page, a particular application, a user interface within an application, a particular location within a particular application, and/or any other suitable place for presenting an advertisement.

In some embodiments, the advertisement space can be received from a list of advertisement spaces on which advertisements can be placed. For example, the advertisement space can be received from an advertiser user selecting the advertisement space from the list of advertisement spaces.

In some embodiments, process 400 can receive a selection of a segment at 404. For example, process 400 can receive a selection of a segment for a potential advertisement to be presented in the selected advertisement space. In some embodiments, the segment can be a medical condition, a demographic, a good and/or service, an advertisement parameter, and/or any others suitable segment. For example, the segment can be a medical condition, such as diabetes type II, high blood pressure, high cholesterol, erectile dysfunction, and/or any other suitable medical condition. In another example, the segment can be a demographic, such as soccer mom, urban professional, people in Atlanta, people ages 18-49, and/or any other suitable demographic. In yet another example, the segment can be a good and/or service, such as sports equipment, tickets, clothes, cars, health services, hotels, flights, rentals, and/or any other suitable goods and/or services. In yet another example, the segment can be an advertisement parameter, such as an advertisement campaign, a trend, a keyword, a topic, a person, a holiday and/or any other suitable advertisement parameter.

In some embodiments, the segment can be received from an advertiser user. For example, the advertiser user can select a segment that the advertiser user wants to advertise to. In a more particular example, a glucose meter manufacturer can select the segment, “Diabetes type II.” In another particular example, a Sports Utility Vehicle (SUV) dealer can select the segment, “Soccer mom.” In yet another example, an energy drink manufacturer can select the segment, “people ages 18-49.”

In some embodiments, the segment can be received from any suitable natural language processing technique. In some embodiments, natural language processing can identify the content of the space around the selected advertisement space. For example, natural language processing can include statistical analysis, optical character recognition (OCR), automatic summarization, keyword extraction, machine translation, sentence breaking, and/or any other suitable natural language processing. In a more particular example, the segment “Diabetes type II” can be received using natural language processing (e.g., statistical analysis) on the space around the selected advertisement space “http://medicalinfo.com/diabetes.” In yet another particular example, the segment “baseball” can be received by using statistical analysis on the space around the selected advertisement space “http://www.sports_news.com/mlb.”

In some embodiments, process 400 can determine at least one score for the selected advertisement space in relation to the selected segment at 406. For example, the score can be based on a relevance of the advertisement space to the segment. A high score can indicate a strong relevance of the advertisement space to the segment. A low score can indicate a low relevance of the advertisement space to the segment.

In some embodiments, the score can additionally or alternatively be based on a location associated with a recipient of the advertisement, which can be determined based on a location associated with a client device on which the advertisement will be presented. For example, the location can be an IP address, a zip code, a location in a mobile application, a geographical location, and/or any other suitable location. In a more particular example, the location can be “Los Angeles, Calif.” In another particular example, the location can be a zip code (e.g., “90077”). In yet another particular example, the location can be an IP address (e.g., “172.16.254.1”).

In some embodiments, the score can be based on the location's relevance to the segment. For example, the location “Zip code 00111” can result in a high score if the segment is “Diabetes type II.” Alternatively, the location “Zip code 00222” can result in a low score if the segment is “Diabetes type II.” In another example, the location “Retirement community” can result in a high score if the segment is “Ages 65-85.” Alternatively, the location “College town” can result in a high score if the segment is “Ages 18-25.” In yet another example, the location “Big city” can result in a high score if the segment is “Urban professional.”

In some embodiments, the score can additionally or alternatively be based on other factors. For example, other factors can be weather data, industry data, government data, social data, search data, and/or any other suitable factors. For example, weather data can be temperature data, humidity data, pollen count, and/or any other suitable weather data. In another example, industry data can be companies in a particular industry, average earnings in a particular industry, competitors in a particular industry, and/or any other suitable industry data. In yet another example, government data can be census data, population data, income data, and/or any other suitable government data. In yet another example, social media data can be social media posts, social friends, social events, and/or any other suitable social data. In yet another example, search data can be a number of times a term is searched for, search results, trending searches, and/or any other suitable search data. In some embodiments, a score can be determined based on one or more suitable factors.

In some embodiments, other factors (e.g., weather data, social data, and/or any other suitable factor relating to a recipient of the advertisement and/or a product or service related to the advertisement) can correspond with a location of a recipient of the advertisement. For example, weather data can be temperature data, humidity data, pollen count, and/or any other suitable weather data of the location of the recipient of the advertisement. In another example, social data can be social friends, social events, and/or any other suitable social data corresponding with the location of the recipient of the advertisement. As described above, the location of a recipient can be based on a location of a client device on which the advertisement will be displayed.

In some embodiments, other factors, such as weather data, industry data, government data, social data, search data, and/or any other suitable data can also be assigned a score in relation to the segment. For example, the weather data “High pollen count” can be assigned a high score if the segment is “Allergies.” In another example, the census data “Age: 27” can be assigned a high score if the segment is “Ages 18-49.” In yet another example, the weather data “88 degrees” can be assigned a high score if the segment is “Swimsuits.” In yet another example, the social data “Paul likes hiking” can be assigned a high score if the segment is “camping equipment.”

In some embodiments, the score can be based on the performance data of the advertisement space. For example, performance data can be user clicks, survey results, downloads, calls to action, social media posts, third party data, and/or any other suitable performance data. In another example, performance data can be the user clicks of an online advertisement. In yet another example, performance data can be a number of successful purchases after the user clicks on the advertisement. In some embodiments, a survey can be on a Web page and ask any suitable questions. For example, the survey can ask “Do you have Diabetes type II.” In some embodiments, survey results can be about the content of the Web page and ask any suitable question. For example, the survey can ask “Was this Web page helpful in regard to Diabetes type II.” In some embodiments, calls to action can solicit an action from a Web page recipient. For example, a call to action can be “Enter you email for a special offer,” “Buy this now,” “Download now,” and/or other suitable calls to action. In some embodiments, the performance data of the advertisement space can be relative to the segment.

In some embodiments, the score can be determined in any suitable manner. For example, the score can be determined using an aggregation of sub-scores for the relevance of the advertising space, the location, the other factors, and/or the performance data. In some embodiments, the sub-scores for the relevance of the advertising space, the location, the other factors, and the performance data can each be assigned a weight value when used to calculate the aggregated score. These weights can be based on a relevance of the sub-scores to the segment, for example. In yet another example, the sub-scores for the relevance of the advertising space, the location, the other factors, and the performance data can each be assigned a weight value based on a popularity to the segment. In yet another example, the sub-scores for the relevance of the advertising space, the location, the other factors, and the performance data can each be assigned a weight value based on an age (e.g., amount of time without an advertisement) of the advertisement space.

In some embodiments, the relevance of the advertising space sub-score, the location sub-score, the other factors sub-score, and the performance data sub-score can be aggregated and normalized in any suitable manner. For example, the sub-score for the relevance of the advertising space, the sub-score for the location (e.g., IP address, zip code(s), and/or any other suitable identifier of a geographic place or area), the sub-score for other factors (e.g., weather data (e.g., temperature, humidity, and/or any other suitable factor relating to a recipient of the advertisement and/or a product or service related to the advertisement)), and the sub-score for the performance data (e.g., user clicks, survey results, and/or any other suitable data relating to the performance of the advertisement) can be aggregated using the following formula:

S_{segment}=W₁S_{relevance, segment}+W₂S_{location, segment}+W₃S_{other factors, segment}+W₄S_{performance data, segment}

wherein, S_{segment} is the score for the segment, S_{relevance, segment} is the score for the relevance of the advertisement space in relation to the segment, S_{location, segment} is the score of the location in relation to the segment, S_{other factors, segment} is the score of the other factors in relation to the segment, and S_{performance data, segment} is the performance data in relation with the segment.

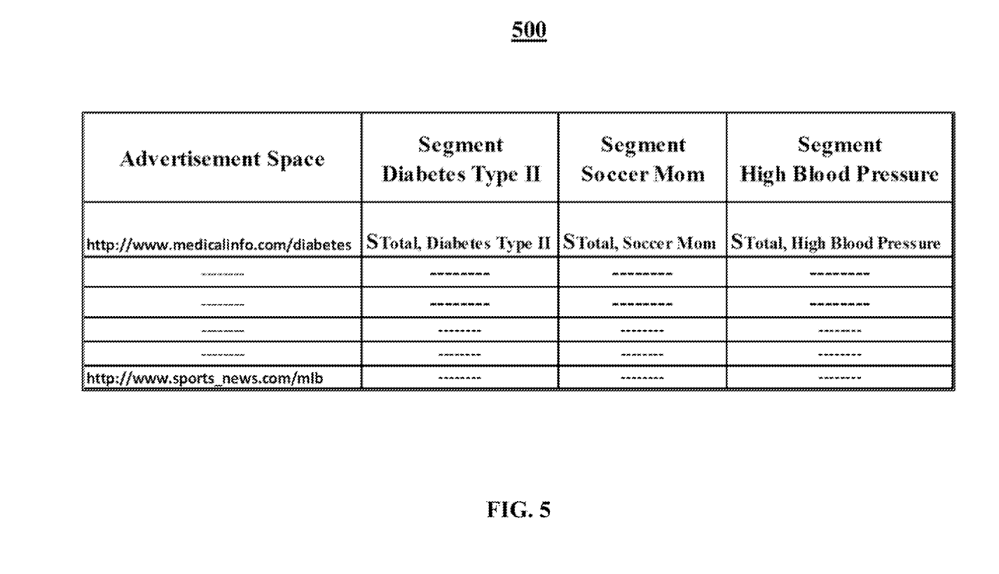

Process 400 can next create a ranking table of the plurality of advertisement spaces based on the scores for the selected advertisement space in relation to the selected segment in any suitable manner at 408. For example, turning to FIG. 5, an example table 500 of a ranking table of a plurality advertisement spaces and one or more segments for each advertisement space is provided. As shown, the plurality of advertisement spaces in table 500 can be ranked highest to lowest based on the corresponding aggregated score (e.g., relevance of the advertisement space, location, other factors, and performance data) for each segment. For example, the highest ranked advertisement space can be the advertisement space with the highest segment score. In a more particular example, as shown in table 500, the advertisement space “http://www.medicalinfo.com/diabetes” has the highest score in relation to the segment “Diabetes Type II.” In another example, the lowest ranked advertisement space can be the advertisement space with lowest segment score. In a more particular example, as shown in table 500, the advertisement space “http://www.sports_news.com/mlb” has the lowest score in relation to the segment “Diabetes Type II.”

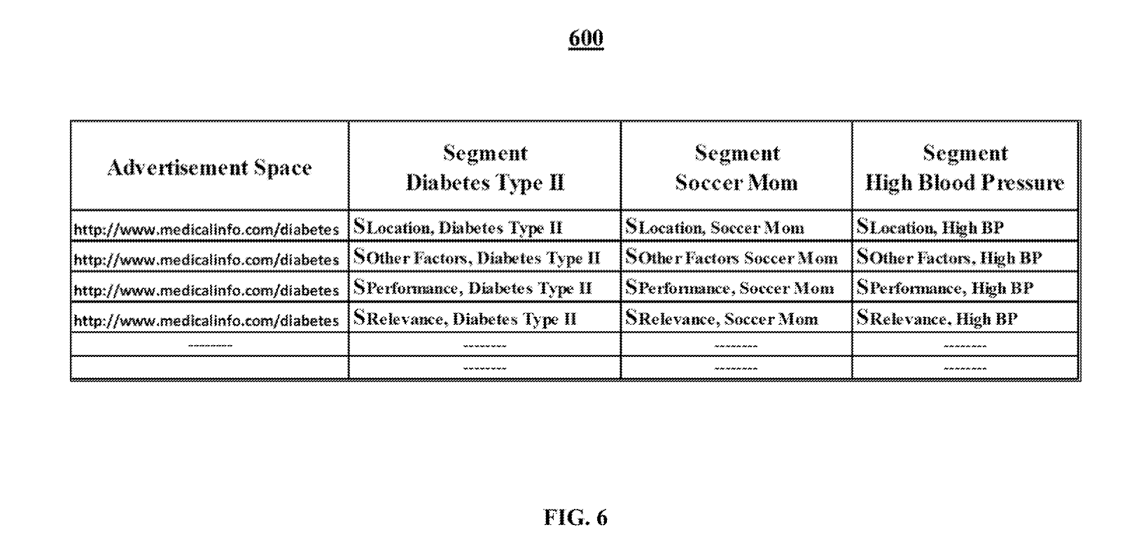

In another example, turning to FIG. 6, an example 600 of a ranking table of a plurality advertisement spaces and one or more segments for each advertisement space is provided. As shown, the plurality of advertisement spaces in table 600 can be ranked highest to lowest based on the corresponding scores for each segment. For example, the highest ranked score within an advertisement space can be the highest score within the segment. In a more particular example, as shown in table 600, the location score within the advertisement space “http://www.medicalinfo.com/diabetes” has the highest score in relation to the segment “Diabetes Type II.”

In some embodiments, the relevance of the advertisement space, the locations, the other factors, and the performance data can be continuously evaluated in any suitable manner. In some embodiments, the relevance of the advertisement space, the locations, the other factors, and the performance data can update the ranking table in real-time. For example, new performance data can be evaluated continuously to adjust the scores upward or downward. In another example, weather data can also be evaluated continuously to adjust the scores upward or downward.

In some embodiments, the ranking table can be filtered based on one or more criteria. For example, the ranking can weight a score higher when the score is higher than a certain score threshold. For example, the ranking can rank the segment “allergy medicine” higher when pollen count is higher than a certain threshold. In some embodiments, the ranking can be ranked based on a season. For example, the ranking can rank the segment “swimwear” higher during the Summer. Additionally or alternatively, the ranking can rank the segment “swimwear” lower during the Winter. In some embodiments, the ranking can be ranked based on an event. For example, the ranking can rank the segment “football” higher during the week leading to the final game of the football season.

In some embodiments, process 400 can determine whether to receive more segments at 410. If process 400 determines to receive more segments, process 400 can loop back to 404. Otherwise, if process 400 determines not to receive any more segments, process 400 can determine whether to receive more advertisement spaces at 412. If process 400 determines to receive more advertisement spaces, process 400 can loop back to 402. Otherwise, if process 400 determines not to receive any more advertisement spaces, process 400 can end.

Turning to FIG. 7, an example process 700 of a method for presenting an advertisement is provided. After creating the ranking table of the plurality of advertisement spaces and one or more segments for each advertisement space based on the scores for advertisement spaces in relation to the segment, process 700 can start by determining whether to use an advertisement recipient's cookie files at 704. Alternatively or additionally, process 700 can determine whether to use any other suitable stored information about an advertisement recipient's. For example, process 700 can use information on the storage device of an advertisement recipient's client device (e.g., browser, mobile device, and/or any other suitable device for presenting advertisements). In another example, process 700 can determine whether to use information stored on a server based on a unique identifier for an advertisement recipient's (e.g., device or browser ID, or user login information).

If advertiser server process determines to use the advertisement recipient's cookie file, then the cookie file can be retrieved at 706. After either retrieving the advertisement recipient's cookie file or not retrieving the advertisement recipient's cookie file, the advertiser server process can receive advertisement space data at 708. In some embodiments, advertisement space data can include the advertisement space's shape, size, format, location, orientation, time stamp, and/or any other advertisement space data. For example, the shape of the advertisement space can be a rectangle, a square, and/or any other suitable shape. In another example, the location of the advertisement space can be above the fold (the advertisement recipient does not have to scroll to see). Alternatively, the location of the advertisement space can be below the fold (the advertisement recipient has to scroll to see). In yet another example, the format of the advertisement space can include whether the advertisement space includes audio and/or video. Additionally and/or alternatively, the format of the advertisement space can include whether the advertisement space is static, floating, and/or any other suitable format. In yet another example, the time stamp of the advertisement space can be in the morning, the afternoon, the nighttime, and/or any other suitable time stamp.

In some embodiments, the advertiser server process can search for a match in the rankings table at 710 and determine whether a match is found at 712. The match can be determined in any suitable manner. For example, the advertiser server process can search the rankings table for a highly ranked segment for the advertisement space. In some embodiments, the match can be any advertisement space (e.g., URL, location on Web page, and/or any other suitable identifier of a place in which an advertisement can be presented) in the ranking table above a particular score threshold. For example, the match can be any advertisement space above a 50% score. In some embodiments, the match can include any advertisement space above a particular rank threshold. For example, the match can be any advertisement space in the top ten of the rankings table.

If it is determined a match has not been found at 712, the advertiser server process can branch to 714 to determine whether to place an advertisement anyway. If it is determined that an advertisement is not to be placed anyway, in some embodiments, the advertiser server process can return no advertisement at 716 and then end at 732. Alternatively, the advertiser server process can select any suitable default advertisement or any suitable default bid at 718 and then end at 732. For example, the default advertisement can be based on the advertisement recipient's cookie data. In another example, the advertiser server process can select a broad advertisement suitable for any segment. In a more particular example, the advertiser server process can select an advertisement for “soda.”

If it is determined that a match has been found at 712, the advertiser server process can identify the best segment for the match at 720. For example, the advertiser server process can select the highest scored segment for the advertisement space. In another example, the advertiser server process can use the advertisement recipient's cookie data to identify the best segment for the match.

In some embodiments, the advertiser server process can determine whether the best segment is good enough to place an advertisement at 722. For example, the advertiser server process can determine whether the best segment is good enough if the segment is above a particular score threshold (e.g., above a 50% score). In yet another particular example, the best segment can be good enough if the segment is above a particular rank threshold (e.g., in the top ten of the rankings table).

If the segment is not good enough, the advertiser server process can return no advertisement at 716 and then end at 732. For example, if the best segment is below a particular score threshold (e.g., below a 50% score), then the advertiser server process can return no advertisement. In another example, if the best segment is below a particular rank threshold (e.g., not in the top ten of the rankings table), then the advertiser server process can also return no advertisement.

Alternatively, if the segment is good enough, the advertiser server process can select an advertisement corresponding to the segment at 724. For example, the advertiser server can determine to advertise a “Glucose meter” if the best segment is “Diabetes type II.” In another example, the advertiser server process can determine to advertise “Sports utility vehicles” if the best segment is “soccer mom.” In yet another example, the advertiser server process can determine to advertise an “energy drink” if the best segment is “Ages 18-49.”

In some embodiments, the advertiser server process can have a maximum threshold for the amount of advertisements placed in a given day, week, month, and/or any other suitable time period. For example, the advertiser server process can have a maximum of ten advertisements placed per day. Additionally or alternatively, the advertiser server process can have a minimum threshold for the amount of advertisements placed in a given day, week, month, and/or any other suitable time period. For example, the advertiser server process can have a minimum of five advertisements placed per day.

In some embodiments, the advertiser server process can also determine a bid price when selecting the advertisement corresponding to the best segment. For example, the advertiser server process can determine the bid price if the advertiser received the request for an advertisement from real-time bidding exchange server 114 (as discussed above in connection with FIG. 3, for example).

In some embodiments, the bid price can be a flat bid price for the advertisement. In some embodiments, the bid price can be associated with the score of the advertisement space and segment. For example, the bid price can be higher for the highest ranked advertisement space. Additionally and/or alternatively, the bid price can be lower for the advertisements for the lowest ranked advertisement space. In a more particular example, the bid price can be a particular amount (e.g., fifty cents) for any selected advertisement. In yet another particular example, the bid price can be a larger amount (e.g., one dollar) for any advertisement above a particular score threshold (e.g., above a 70% score).

In some embodiments, the bid price can be determined by using trial and error to determine the optimal bid. For example, the bid price can start low and then slowly be raised. In some embodiments, the bid price can correspond to a frequency of the advertisement space. For example, the bid price can be high if the frequency (e.g., amount of times the advertisement space is shown to a Web page recipient) of the advertisement space is high. Alternatively, the bid price can be low if the frequency of the advertisement space is low. In some embodiments, the bid price can correspond to the age (e.g., length of time without an advertisement) of the advertisement space. For example, the bid price can be high if the age of the advertisement space is low. Alternatively, the bid price can be low if the age of the advertisement space is high.

In some embodiments, the bid price can be determined by combining a plurality of scores of an advertisement space and a segment. For example, the bid price can be determined by using a score for the relevance of the advertisement space, a score for the location, a score for the performance data, and a score for the weather. In some embodiments, each score within the combination can be rated. For example, each score can be rated either low, medium, or high. In a more particular example, the bid price can be $3.00 if the location score is rated high and the performance data score is rated high and the weather score is rated medium. In some embodiments, the bid price can be combined using Boolean operators (e.g., AND, OR, NOT, and/or any other suitable separating operator) to separate the different scores.

After selecting the advertisement (and corresponding bid) for the best segment, the advertiser server process can return the advertisement (and corresponding bid) to the client server and/or to the real-time bidding exchange server process at 726 (as discussed in further detail above in connection with FIGS. 2 and 3, for example).

In some embodiments, the real-time bidding exchange process can include a data application and buying application to mark and buy a plurality of advertisement spaces. For example, the data application can mark a plurality of advertisement space as potential matches with corresponding bid prices. In a more particular example, the data application can mark the plurality of advertisements within the ranking table. In some embodiments, the buying application can buy the advertisement space based on the bid price of the data application. For example, the buying application can buy only the advertisement spaces that the data application marked as a match.

Turning back to FIG. 7, process 700 can determine whether to write the advertisement recipient's cookie file at 728. If the advertiser sever determines to write the advertisement recipient's cookie file, the advertiser server process can write the segment data to the advertisement recipient's cookie file at 730. For example, the advertiser server process can write the ranking table to the advertisement recipient's cookie file on the advertisement recipient's browser. In a more particular example, the advertiser server process can write the highest ranked segments to the advertisement recipient's cookie files. Additionally or alternatively, the advertiser server process can skip to writing the lowest ranked segments to the advertisement recipient's cookie files. The cookie files can be stored in any suitable manner and/or location.

If the advertiser server process determines to not write the advertisement recipient's cookie files at 728 or after writing the cookie file at 730 then, process 700 can end at 732.

It should be understood that the above steps of the flow diagrams can be executed or performed in any order or sequence not limited to the order and sequence shown and described in the figures. Also, some of the above steps of the flow diagrams can be executed or performed substantially simultaneously where appropriate or in parallel to reduce latency and processing times.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, and/or any other suitable device(s) for storing programs and/or data using magnetic charge), optical media (such as compact discs, digital video discs, Blu-ray discs, and/or any other suitable device(s) for storing programs and/or data using optical properties), semiconductor media (such as flash memory, electrically programmable read only memory (EPROM), electrically erasable programmable read only memory (EEPROM), and/or any other suitable device(s) for storing programs and/or data using semiconductors), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Referring back to FIG. 1, communications network 106 may be any suitable computer network including the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. Communications links 104 and 108 may be any communications links suitable for communicating data between client 102 and server 110, server 112, and/or server 114, such as network links, dial-up links, wireless links, hard-wired links, any other suitable communications links, or a combination of such links. Client 102 and server 110, server 112, and/or server 114 may be located at any suitable location. In some embodiments, client 102 and server 110, server 112, and/or server 114 may be located within an organization. Alternatively, client 102 and server 110, server 112, and/or server 114 may be distributed between multiple organizations.

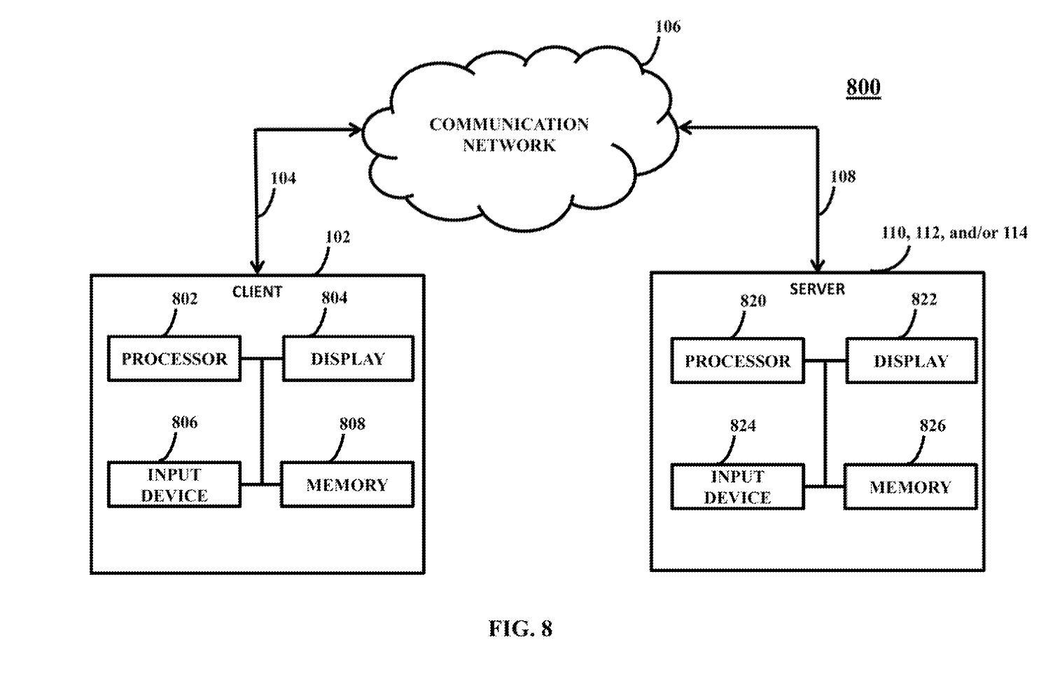

Examples of server 110, server 112, server 114, and/or client 102 depicted in FIG. 1 are illustrated in more detail in FIG. 8. As shown in FIG. 8, client 102 may include processor 802, display 804, input device 806, and memory 808, which may be interconnected. In some embodiments, memory 808 can contain a storage device for storing a computer program for controlling processor 802.

Processor 802 can use the computer program to present on display 804 the data received through communications link 104 and commands and values transmitted by a user of client 102. It should also be noted that data received through communications link 104 or any other communications links may be received from any suitable source. Input device 806 may be a computer keyboard, a mouse, a cursor-controller, dial, switchbank, lever, or any other suitable input device as would be used by a designer of input systems or process control systems. Alternatively, input device 806 may be a finger or stylus used on a touch screen display 804.

Server 110, server 112, and/or server 114 may include processor 820, display 822, input device 824, and memory 826, which may be interconnected. In some embodiments, memory 826 can contain a storage device for storing data received through communications link 108 or through other links, and also receive commands and values transmitted by one or more users. The storage device can further contain a server program for controlling processor 820.

In some embodiments, the computer program may include client-side software, hardware, or both. For example, the computer program may encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

Although the application is described herein as being implemented on a user computer and/or server, this is only illustrative. The application may be implemented on any suitable platform (e.g., a personal computer (“PC”), a mainframe computer, a data display, a two-way pager, a wireless terminal, a portable telephone, a portable computer, a palmtop computer, an automobile PC, a laptop computer, a cellular phone, a personal digital assistant (“PDA”), a tablet computer, a smart phone, a combined cellular phone and PDA, and/or any other suitable device(s) for performing the functions described herein) to provide such features.

Accordingly, systems, methods, and media for presenting an advertisement are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for presenting an advertisement comprising:
at least one hardware processor that:
receives information relating to an advertisement space;
determines at least one score for each of a plurality of segments for a potential advertisement for the advertisement space;
selects a segment from the plurality of segments for the advertisement space based on the at least one score for the plurality of segments;
selects an advertisement for the segment selected; and
causes the advertisement to be presented in the advertisement space.

2. The system of claim 1, further comprising at least one hardware processor that determines a bid for the advertisement.

3. The system of claim 2, wherein the bid is based on the at least one score.

4. The system of claim 2, wherein the bid is based on a frequency of the advertisement space.

5. The system of claim 1, wherein at least one of the plurality of segments is an advertisement parameter.

6. The system of claim 1, wherein the at least one score is an aggregation of a plurality of scores.

7. The system of claim 1, wherein the at least one score is based on the relevance of the advertisement space.

8. The system of claim 1, wherein the at least one score is based on a location.

9. The system of claim 1, wherein the at least one score is based on a performance of the advertisement space.

10. The system of claim 1, wherein the at least one score is based on a plurality of factors.

11. A method for presenting an advertisement comprising:
receiving, using a hardware processor, information relating to an advertisement space;
determining, using the hardware processor, at least one score for each of a plurality of segments for a potential advertisement for the advertisement space;
selecting a segment from the plurality of segments for the advertisement space based on the at least one score for the plurality of segments;
selecting an advertisement for the segment selected; and
causing the advertisement to be presented in the advertisement space.

12. The method of claim 11, further comprising determining a bid for the advertisement.

13. The method of claim 12, wherein the bid is based on the at least one score.

14. The method of claim 12, wherein the bid is based on a frequency of the advertisement space.

15. The method of claim 11, wherein at least one of the plurality of segments is an advertisement parameter.

16. The method of claim 11, wherein the at least one score is an aggregation of a plurality of scores.

17. The method of claim 11, wherein the at least one score is based on the relevance of the advertisement space.

18. The method of claim 11, wherein the at least one score is based on a location.

19. The method of claim 11, wherein the at least one score is based on a performance of the advertisement space.

20. The method of claim 11, wherein the at least one score is based on a plurality of factors.

21. A non-transitory computer-readable medium containing computer-executable instructions that, when executed by a hardware processor, cause the processor to perform a method for presenting an advertisement, the method comprising:
receiving information relating to an advertisement space;
determining at least one score for each of a plurality of segments for a potential advertisement for the advertisement space;
selecting a segment from the plurality of segments for the advertisement space based on the at least one score for the plurality of segments;
selecting an advertisement for the segment selected; and
causing the advertisement to be presented in the advertisement space.

22. The non-transitory computer-readable medium of claim 21, further comprising determining a bid for the advertisement.

23. The non-transitory computer-readable medium of claim 22, wherein the bid is based on the at least one score.

24. The non-transitory computer-readable medium of claim 22, wherein the bid is based on a frequency of the advertisement space.

25. The non-transitory computer-readable medium of claim 21, wherein at least one of the plurality of segments is an advertisement parameter.

26. The non-transitory computer-readable medium of claim 21, wherein the at least one score is an aggregation of a plurality of scores.

27. The non-transitory computer-readable medium of claim 21, wherein the at least one score is based on the relevance of the advertisement space.

28. The non-transitory computer-readable medium of claim 21, wherein the at least one score is based on a location.

29. The non-transitory computer-readable medium of claim 21, wherein the at least one score is based on a performance of the advertisement space.

30. The non-transitory computer-readable medium of claim 21, wherein the at least one score is based on a plurality of factors.
